(19) United States
(12) Patent Application Publication
(10) Pub. No.: US 2003/0175035 A1
(43) Pub. Date: Sep. 18, 2003

(54) Light pipe extension between a mobile device and an imaging device

(76) Inventor: Edward Brett Hunt, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/100,207

(22) Filed: Mar. 13, 2002

(51) Int. Cl. H04B 10/12

(52) U.S. Cl. 398/156; 398/116; 398/141; 398/127; 398/164

(57) ABSTRACT

This invention relates to light pipe extensions. Such structures of this type, generally, allow for machine-readable data to be transmitted from a mobile device, such as a laptop computer, to an imaging device, such as a printer. Also, this structure provides a means for which the machine-readable data can be transmitted around obstacles. For example, the obstacle might be the fact that the imaging device is located on top of a media-handling device and the mobile device does not have a direct line of sight to the imaging device.

### FIELD OF THE INVENTION

This invention relates to light pipe extensions. Such structures of this type, generally, allow for machine-readable data to be transmitted from a mobile device, such as a laptop computer, to an imaging device, such as a printer. Also, this structure provides a means for which the machine-readable data can be transmitted around obstacles. For example, the obstacle might be the fact that the imaging device is located on top of a media-handling device and the mobile device does not have a direct line of sight to the imaging device.

### DESCRIPTION OF THE RELATED ART

Prior to the present invention, as set forth in general terms above and more specifically below, it is known, in the light pipe art, to employ a light pipe for use in emitting light. Exemplary of such prior art is U.S. Pat. No. 4,71 5,700 ('700) to M. Daniel, entitled “Light Emitting Optical Fiber Assemblies Including Light Controlling.” While the '700 reference discloses the use of a light pipe, the light pipe is used only to transmit light and not machine-readable data. Also, there is no teaching, suggestion or even appreciation for using the light pipe to transmit the machine-readable data around an obstacle.

It is also known, in the light pipe art, to employ a light pipe for use in connecting fiber optics. Exemplary of such prior art is U.S. Pat. No. 4,496,211 ('211) to M. Daniel, entitled “ Light Pipe Network With Optical Devices for Distributing Electromagnetic Radiation.” While the '211 reference discloses various ways of connecting and creating networks of light pipes, this reference is used only to transmit electromagnetic radiation. Also, there is no teaching, suggestion or even appreciation for using the light pipe to transmit the machine-readable data around an obstacle.

Finally, it is known, in the light pipe art, to employ a light pipe for transporting light. Exemplary of such prior art are U.S. Pat. No. 4,750,837 ('837) to C. R. Gifford et al., entitled “Fluorometer With Reference Light Source”, U.S. Pat. No. 4,802,768 ('768) to C. R. Gifford et al., entitled “Two Light Source Reference System for a Fluorometer,” and U.S. Pat. No. 6,310,440 ('440) to A. T. Lansing et al., entitled “System for Individual and Remote Control of Spaced Lighting Fixtures.” While the '837, '768, and '440 references disclose the use of a light pipe, again, the light pipe is used only to transmit light and not machine-readable data. Also, there is no teaching, suggestion or even appreciation for using the light pipe to transmit the machine-readable data around an obstacle.

It is apparent from the above that there exists needed in the art for a light pipe extension which is lightweight through simplicity of parts and uniqueness of structure, but which can transmit machine-readable data from a mobile device to an imaging device and is capable of transmitting the machine-readable data around obstacles. It is a purpose of this invention to fulfill this and other needs in the art in a manner more apparent to the skilled artisan once given the following disclosure.

### SUMMARY OF THE INVENTION

Generally speaking, this invention fulfills these needs by providing a light pipe extension system, wherein the system is comprised of: a mobile device which is capable of emitting machine-readable data contained in an electronic signal; an imaging device located substantially out of a line of sight of the mobile device wherein the imaging device is capable of receiving the machine-readable data; and a light pipe extension means operatively connected to the mobile device and the imaging device for transmitting the machine-readable data.

In certain preferred embodiments, the mobile device can be, but is not limited to, a desktop computer, a laptop computer, a personal digital assistant (PDA) or the like. Also, the imaging device can be, but is not limited to, a printing device, a digital sender, a scanner or the like. Finally, the machine-readable data is encoded in the light beam transmitted from the mobile device to the imaging device.

In another further preferred embodiment, the light pipe extension is used to transmit machine-readable data from the mobile device to the imaging device even if the imaging device is located outside of the line of sight of the mobile device.

The preferred light pipe extension system, according to this invention, offers the following advantages: lightness in weight; ease of assembly and repair; excellent encoded light transmission characteristics; ease of transmitting the encoded light around obstacles; good stability; good durability; and excellent economy. In fact, in many of the preferred embodiments, these factors of lightness in weight, ease of assembly and repair, excellent encoded light transmission characteristics, and ease of transmitting the encoded light around obstacles are optimized to an extent that is considerably higher than heretofore achieved in prior, known light pipe systems.

The above and other features of the present invention, which will become more apparent as a description proceeds, are best understood by considering the following detailed description in conjunction with the company drawings, wherein like characters represent like parts throughout the several views and in which:

### BRIEF DESCRIPTION OF THE DRAWINGS

FIGS. 1a and 1b are front and side schematic illustrations, respectively, of a mobile device trying to transmit machine-readable data to an imaging device, according to prior art;

FIGS. 2a and 2b are front and side schematic illustrations, respectively, of a light pipe extension system for use in transmitting machine-readable data between a mobile device and an imaging device, according to one embodiment of the present invention;

FIGS. 3a and 3b are front and side schematic illustrations, respectively, of another light pipe extension system for use in transmitting machine-readable data between a mobile device and an imaging device, according to another embodiment of the present invention; and

FIGS. 4a and 4b are front and side schematic illustrations, respectively, of still another light pipe extension system for use in transmitting machine-readable data between a mobile device and an imaging device, according to a further embodiment of the present invention.

### DETAILED DESCRIPTION OF THE INVENTION

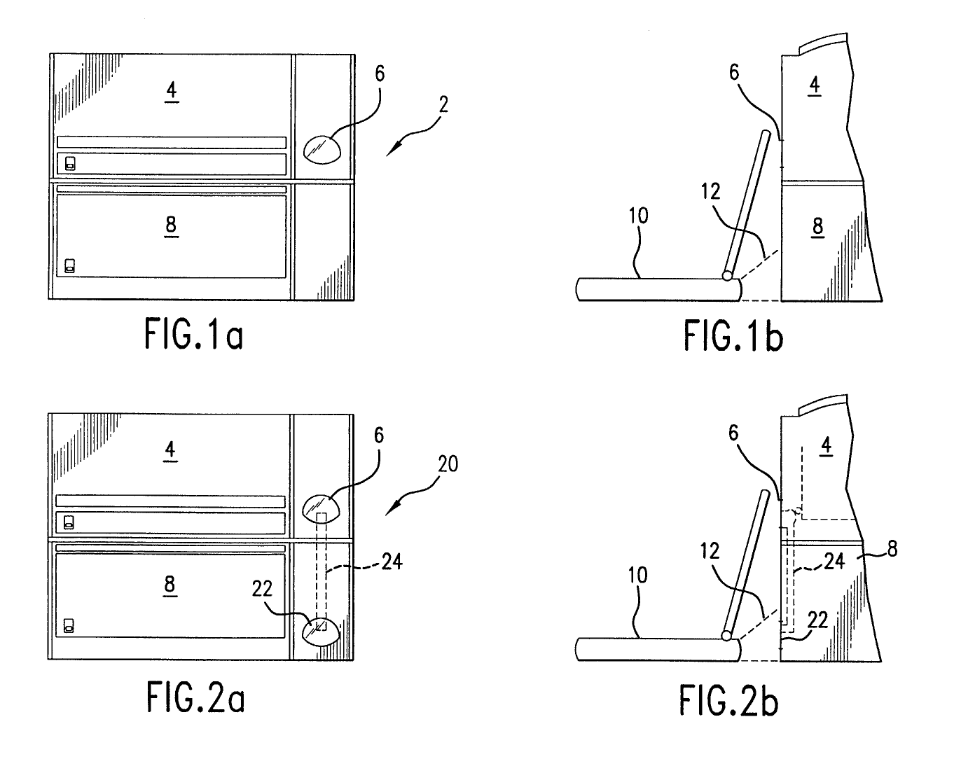

With respect to FIGS. 1a and 1b, there is illustrated a typical set up 2 involving an imaging device 4 and a mobile device 10, according to the prior art. As shown in FIG. 1a, a conventional imaging device 4 having an infrared (IR) window 6 is located on top of a conventional media-handling device 8. As shown in FIG. 1b, conventional mobile device 10 emits a conventional electronic fast infrared (FIR) signal 12 that contains discrete bits of machine-readable data that are capable of being read by imaging device 4. However, electronic signal 12 is not able to interact with imaging device 4 because electronic signal 12 does not impinge upon IR window 6. This is due to the fact that imaging device 4 is located on top of media-handling device 8. Instead, the user would have to lift up mobile device 10 in order to allow electronic signal 12 to impinge upon IR window 6. This could be very problematic for the user if the user has to download any substantial amount of data from mobile device 10 to imaging device 4. Consequently, a more advantageous system, then, would be presented if the electronic signal 12 could be read by imaging device 4 regardless of the location of imaging device 4 with respect to mobile device 10.

With reference to FIGS. 2a and 2b, there is illustrated one preferred embodiment for use of the concepts of this invention. As shown in FIG. 2a, light pipe extension system 20 is illustrated. Light pipe extension system 20 includes, in part, conventional imaging device 4, conventional IR window 6, conventional media-handling device 8, conventional mobile device 10, conventional electronic FIR signal 12, IR window 22, and light pipe extension 24. It is to be understood that imaging device 4 can be, but is not limited to, printing devices, digital senders, scanners or the like. It is also to be understood that media-handling device 8 can be, but is not limited to, sheet feeders, duplexers, staplers or the like. Finally, is to be understood that mobile device 10 can be, but is not limited to, a computer, a personal digital assistant (PDA), a laptop computer or the like.

In this embodiment, light pipe extension 24 is, preferably, located within imaging device 4 and media-handling device 8. As shown in FIGS. 2a and 2b, the user merely has to set mobile device 10 on the same platform as media-handling device 8 and download the machine-readable data through electronic signal 12 into IR window 22 through light pipe extension 24 and into imaging device 4. It is to be understood that the length of light pipe extension 24 can be varied so long as light pipe extension 24 is operatively connected to IR window 6 and IR window 22.

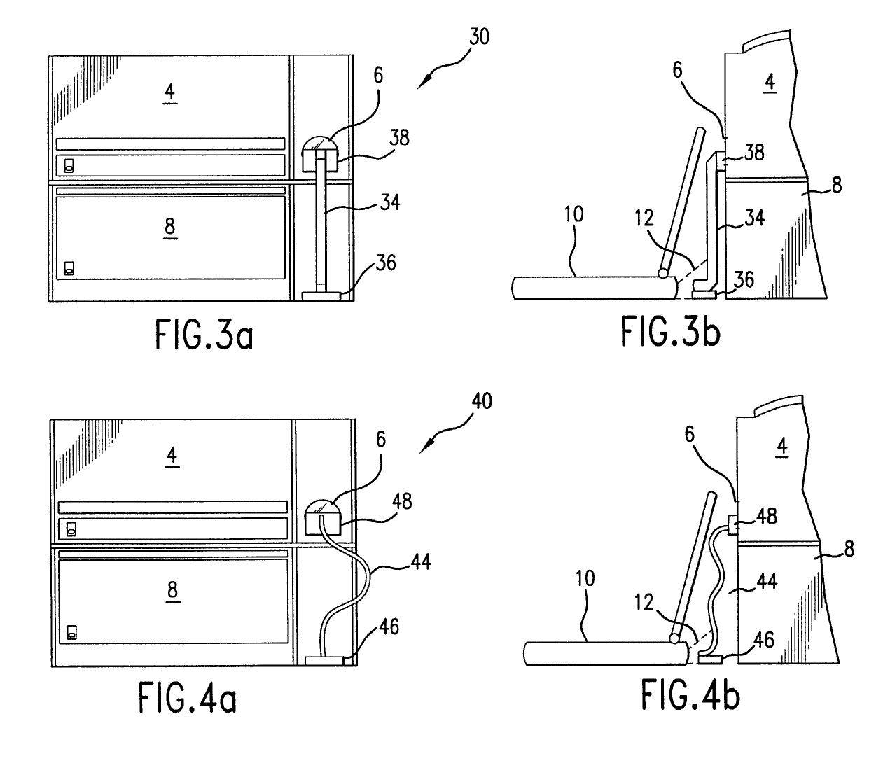

With reference to FIGS. 3a and 3b, there is illustrated another preferred embodiment for use of the concepts of this invention. As shown in FIG. 3a, light pipe extension system 30 is illustrated. Light pipe extension system 30 includes, in part, conventional imaging device 4, conventional IR window 6, conventional media-handling device 8, conventional mobile device 10, conventional electronic FIR signal 1 2, rigid light pipe extension 34, light pipe extension support 36, and light pipe extension mounting bracket 38.

In this second embodiment, rigid light pipe extension 34 is, preferably, located along the outside of imaging device 4 and media-handling device 8. Light pipe extension support 36 is, preferably, conventionally connected to rigid light pipe extension 34 and is constructed of any suitable rigid, durable material that is capable of providing support for rigid light pipe extension 34. Light pipe extension mounting bracket 38 is, preferably, conventionally connected to rigid light pipe extension 34 and is constructed of any suitable, rigid, durable material that is capable of affixing light pipe extension 34 to imaging device 4 without blocking either the light pipe signal or another infrared signal that is not traveling through light pipe extension 34. It is to be understood that the length of printed light pipe extension 34 can be varied so long as rigid light pipe extension 34 is operatively connected to electronic signal 12 and IR window 6.

With reference to FIGS. 4a and 4b, there is illustrated still another preferred embodiment for use of the concepts of this invention. As shown in FIG. 4a, light pipe extension system 40 is illustrated. Light pipe extension system 40 includes, in part, conventional imaging device 4, conventional IR window 6, conventional media-handling device 8, conventional mobile device 10, conventional electronic FIR signal 12, flexible light pipe extension 44, light pipe extension support 46, and light pipe extension mounting bracket 48.

In this third embodiment, flexible light pipe extension 44 is, preferably, located along the outside of imaging device 4 and media-handling device 8. Flexible light pipe extension support 46 is, preferably, conventionally connected to flexible light pipe extension 44 and is constructed of any suitable rigid, durable material that is capable of providing support for flexible light pipe extension 44. Light pipe extension mounting bracket 48 is, preferably, conventionally connected to flexible light pipe extension 44 and is constructed of any suitable rigid, durable material that is capable of affixing light pipe extension 44 to imaging device 4 without blocking either the light pipe signal or another infrared signal that is not traveling through light pipe extension 44. It is to be understood that the length of flexible light pipe extension 44 can be varied so long as flexible light pipe extension 44 is operatively connected to electronic signal 12 and IR window 6. It is also to be understood that flexible light pipe extension 44 can be located along the inside of imaging device 4 and media-handling device 8 in a manner similar to that illustrated by light pipe extension 24 in FIGS. 2a and 2b.

With respect to the present invention, it is to be understood that while imaging device 4 is illustrated as being located on top of media-handling device 8, imaging device 4 may very well be located below media-handling device 8. For example, imaging device 4 may be recessed under a conventional workstation upon which a media-handling device 8 is placed. The present invention can easily be modified to address this situation by using, for example, flexible light pipe extension 44. In this manner, the length of flexible light pipe extension 44 can be adjusted such that electronic FIR signal 12 from mobile device 10 can be easily transmitted to IR window 6 of recessed imaging device 4.

It is to be understood that light pipe extension systems 30 and 40 (FIGS. 3a , 3b , 4a, and 4b) can be provided to the user as easily installed add-on kits. The user merely has to secure light pipe extension connectors 38 or 48 to IR window 6 of imaging device 4.

Finally, it is to be understood that the present invention could be used anytime there is a need to direct an infrared or electronic-type signal data stream around an obstacle. For example, if a VCR, CD player or the like are hidden behind a wall, the present invention could be utilized to operate those “hidden” devices without having to be on the other side of the wall.

Once given the above disclosure, many other features, modifications or improvements will become apparent to the skilled artisan. Such features, modification or improvements are, therefore, considered to be a part of this invention, the scope of which is to determined by the following claims.

What is claimed is:

1. A light pipe extension system, comprising:
a mobile device which is capable of emitting machine-readable data contained in an electronic signal;
an imaging device located substantially out of a line of sight of said mobile device wherein said imaging device is capable of receiving said machine-readable data; and
a light pipe extension means operatively connected to said mobile device and said imaging device for transmitting said machine-readable data.

2. The system, as in claim 1, wherein said mobile device is further comprised of:
a personal digital assistant.

3. The system, as in claim 1, wherein said mobile device is further comprised of:
a laptop computer.

4. The system, as in claim 1, wherein said machine-readable data is further comprised of:
discrete bits of machine-readable data.

5. The system, as in claim 1, wherein said light pipe extension means is further comprised of:
a light pipe extension;
a light pipe extension support means operatively connected to one end of said light pipe extension; and
a light pipe extension mounting bracket means operatively connected to another end of said a light pipe extension.

6. The system, as in claim 5, wherein said light pipe extension is further comprised of:
a rigid light pipe extension.

7. The system, as in claim 5, wherein said light pipe extension is further comprised of:
a flexible light pipe extension.

8. The system, as in claim 1, wherein said imaging device is located substantially on top of a media-handling device.

9. The system, as in claim 1, wherein said imaging device is substantially recessed in a workstation.

10. The system, as in claim 1, wherein said imaging device is further comprised of:
an IR window.

11. The system, as in claim 8, wherein said light pipe extension means is substantially located within said imaging device and said media-handling device.

12. The system, as in claim 8, wherein said light pipe extension means is substantially located along the outside of said imaging device and said media-handling device.

13. The system, as in claim 9, wherein said light pipe extension means is substantially located within said imaging device and said media-handling device.

14. The system, as in claim 9, wherein said light pipe extension means is substantially located along the outside of said imaging device and said media-handling device.
